(19) United States
(12) Patent Application Publication
(10) Pub. No.: US 2026/0243109 A1
(43) Pub. Date: Aug. 20, 2026

(54) Locking Device with Function of Preventing Accidental Unlocking, and Lock Provided with Same

(71) Applicant: Shenzhen Kuze Tongchuang Technology Co., Ltd, Shenzhen (CN)

(72) Inventor: Haidong CHEN, Shenzhen (CN)

(21) Appl. No.: 19/056,785

(22) Filed: Feb. 19, 2025

(51) Int. Cl. E05B 65/00

(52) U.S. Cl. CPC E05B 65/0014

(57) ABSTRACT

Disclosed is a locking device with a function of preventing accidental unlocking. The device includes a housing provided with a semi-open cavity. The device further includes a locking mechanism and a rotating member, the locking mechanism is movably connected to an interior of the cavity, and the rotating member is movably connected to the locking mechanism. When in use, the locking mechanism is unlocked by pressing the rotating member after rotation of the rotating member, or the locking mechanism is locked by rotating the rotating member. When the locking mechanism is in a locked state, one side of the rotating member rotates to a top of one side of the housing.

### TECHNICAL FIELD

The present disclosure relates to the technical field of locks, and in particular to a locking device with a function of preventing accidental unlocking, and a lock provided with same. The locking device and the lock provided with same are particularly suitable for the technical field of preventing children from unlocking accidentally.

### BACKGROUND

With the development and progress of science and technology, more and more kinds of household appliances are used in people’s daily life. Because children are still in an active age stage, they are very curious about everything and cannot distinguish the danger of things around them. However, there are many potential unsafe factors in a family environment. When a washing machine or a toilet is opened, there may be phenomena of fingers, arms, ankles, head, and body parts getting stuck. It often occurs that children get their fingers crushed and injured while opening drawers, bookcases, and wardrobes. Children are prone to opening refrigerators, gas cabinets, microwave ovens, and doors of important lockers when playing at home, which poses a great danger to both property and their own safety.

Upon searching of the prior background art, it is found that child safety locks on the market use flip fasteners for locking, which are easy to be unlocked by children’s imitation, and thus cannot completely eliminate a situation of unlocking by children. There is also a child safety lock locked by buckles pressed on both sides. Due to the complex structure and operation skills, it is not easy for children to imitate and unlock, and it is also difficult for adults to operate. Furthermore, in order to make it possible for fingers to press on both sides, the volume and thickness are also relatively large. Once assembled, a connecting band cannot be adjusted freely; and the structure is complex, and the cost will be relatively high.

In view of the technical defects of the existing child safety locks, it is necessary to propose a lock that is safer and easier to operate (convenient for adults to open, but difficult for children to unlock).

### SUMMARY

In order to address the shortcomings in the prior art, the present disclosure aims to provide a locking device with a function of preventing accidental unlocking, and further provide a lock provided with the locking device with a function of preventing accidental unlocking.

In short, through the structural cooperation between a rotating member and a locking mechanism, the present disclosure can achieve unlocking by pressing the rotating member after rotation of the rotating member. At the same time, the rotating member can be locked during locking. The “two-step” unlocking method satisfies the convenience of unlocking with one hand for adults, but for children, it can effectively prevent the lock from being unlocked accidentally. In addition, a connecting band of the lock provided by the present disclosure is made of a flexible material and is provided with a plurality of equidistant fixing holes, so that a length of the connecting band can be freely adjusted by a user.

In order to achieve the above objectives, the present disclosure adopts the following technical solutions:

A locking device with a function of preventing accidental unlocking are provided. The device includes a housing provided with a semi-open cavity, and further includes a locking mechanism and a rotating member, the locking mechanism is movably connected to an interior of the cavity, and the rotating member is movably connected to the locking mechanism. When in use, the locking mechanism is unlocked by pressing the rotating member after rotation of the rotating member, or the locking mechanism is locked by rotating the rotating member. When the locking mechanism is in a locked state, one side of the rotating member rotates to a top of one side of the housing.

It should be noted that the locking mechanism includes a movable plate and a spring, the movable plate is provided with a groove penetrating from top to bottom, one end of the spring is connected to an outer side wall of the groove in a penetrating manner, and the other end of the spring is abutted against a bottom inner surface of the cavity; one side of the movable plate is rotatably connected to the interior of the cavity, the other side of the movable plate is provided with a lock tongue, a side wall of the housing is provided with a slot, and the lock tongue is located inside the slot; the rotating member is connected to an interior of the groove in a penetrating manner; and when the locking mechanism is in an unlocked state, one side of the rotating member rotates to a top of the movable plate.

It should be noted that a connecting column is arranged at a bottom of the rotating member, and a limit flange is provided at a peripheral edge of a side wall of one end of the connecting column; and when the rotating member is connected to the interior of the groove in a penetrating manner, the limit flange is abutted against an end face of a bottom peripheral edge of the groove.

It should be noted that an interstice available for rotation of the connecting column is reserved between a side wall of the connecting column and an inner side wall of the groove.

It should be noted that rotating flanges are respectively provided on one side of the movable plate, and the cavity is internally provided with openings formed at positions respectively corresponding to the rotating flanges; when one side of the movable plate is rotatably connected to the interior of the cavity, the rotating flanges are rotatably connected to interiors of the openings; and when the rotating member rotates to a designated position, the movable plate is enabled to rotate along the rotating flanges while the rotating member is pressed.

It should be noted that positioning members are respectively arranged on opposite sides of a top peripheral edge of the groove, one ends of the positioning members are fixedly connected to a surface of the movable plate, and the other ends of the positioning members are free ends; positioning flanges are provided on tops of the other ends of the positioning members, and a plurality of positioning grooves are formed in a bottom peripheral edge of the rotating member; and when the rotating member is connected to the interior of the groove in a penetrating manner, the positioning flanges are located in any of the positioning grooves.

It should be noted that handles are respectively formed on opposite sides of the rotating member in a manner of extending outward; and when the locking mechanism is in the locked state, one of the handles is located on the top of one side of the housing.

The present disclosure further provides a lock provided with the locking device with a function of preventing accidental unlocking. The lock includes a connecting band and a fixing mechanism, where a plurality of fixing holes are reserved at one side of the connecting band, and a locking hole is reserved at the other side of the connecting band; the fixing mechanism is movably connected to any of the fixing holes; and when the locking mechanism is in the locked state, the lock tongue is connected to an interior of the locking hole.

It should be noted that the fixing mechanism includes a fixed cover and a fixed seat movably connected to the fixed cover; a positioning column is arranged on a surface of the fixed seat, and a bottom of the fixed cover is provided with a fastening column at a position corresponding to the positioning column; and when in use, the positioning column is connected to an interior of any of the fixing holes in a penetrating manner, and the fastening column is inserted into the positioning column.

It should be noted that bottom outer surfaces of the locking mechanism and the fixing mechanism are respectively provided with traceless adhesive for bonding.

The present disclosure has the beneficial effects that both the locking mechanism and the fixing mechanism occupy a smaller space; the locking mechanism is simple in structure and high in applicability; and the unlocking steps of rotating and pressing can be operated by an adult with one hand, while reducing the possibility of children accidentally unlocking.

### BRIEF DESCRIPTION OF FIGURES

FIG. 1 is a schematic exploded view of the structure of a locking device with a function of preventing accidental unlocking according to the present disclosure;

FIG. 2 is a schematic diagram of the cross-sectional structure of the locking device with a function of preventing accidental unlocking according to the present disclosure;

FIG. 3 is a schematic structural diagram of a rotating member in FIG. 1;

FIG. 4 is a schematic structural diagram of the locking device with a function of preventing accidental unlocking according to the present disclosure in a locked state;

FIG. 5 is a schematic structural diagram of a connecting band in a lock provided with the locking device with a function of preventing accidental unlocking according to the present disclosure;

FIG. 6 is a schematic structural diagram of a fixing mechanism in the lock provided with the locking device with a function of preventing accidental unlocking according to the present disclosure;

FIG. 7 is a schematic diagram of the cross-sectional structure showing a locking connection between the locking device and the connecting band in the lock provided with the locking device with a function of preventing accidental unlocking according to the present disclosure;

FIG. 8 is a schematic structural diagram of the lock provided with the locking device with a function of preventing accidental unlocking according to the present disclosure in a first unlocked state;

FIG. 9 is a schematic structural diagram of the lock provided with the locking device with a function of preventing accidental unlocking according to the present disclosure in a second unlocked state;

FIG. 10 is a schematic diagram of the cross-sectional structure of the lock provided with the locking device with a function of preventing accidental unlocking according to the present disclosure in the second unlocked state;

FIG. 11 is another schematic diagram of the positioning column of the fixed seat provided with the locking device with a function of preventing accidental unlocking according to the present disclosure;

FIG. 12 is another schematic diagram of the fixed cover connected to the fixed seat provided with the locking device with a function of preventing accidental unlocking according to the present disclosure;

FIG. 13 is a schematic diagram of the lock provided with the locking device with a function of preventing accidental unlocking according to the present disclosure in a locked usage state.

### DETAILED DESCRIPTION

The technical solutions in embodiments of the present disclosure will be described clearly and completely hereinafter with reference to the accompanying drawings in the embodiments of the present disclosure. Apparently, the described embodiments are only a part rather than all of the embodiments of the present disclosure.

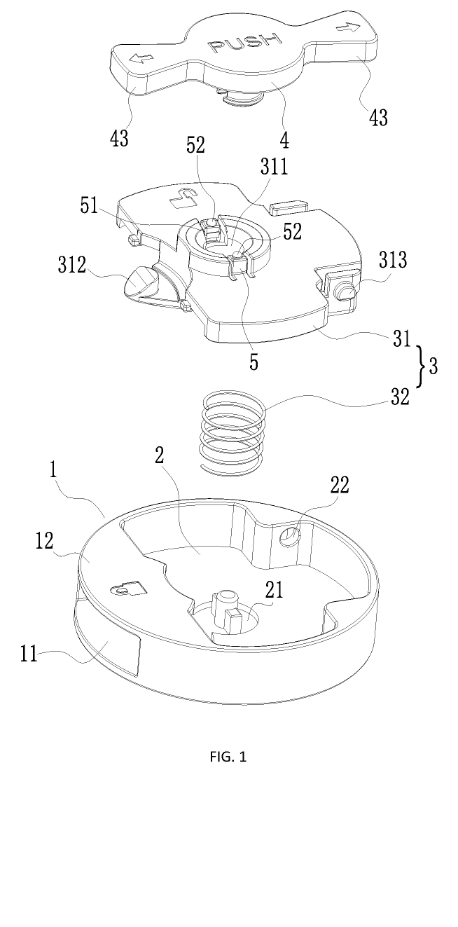

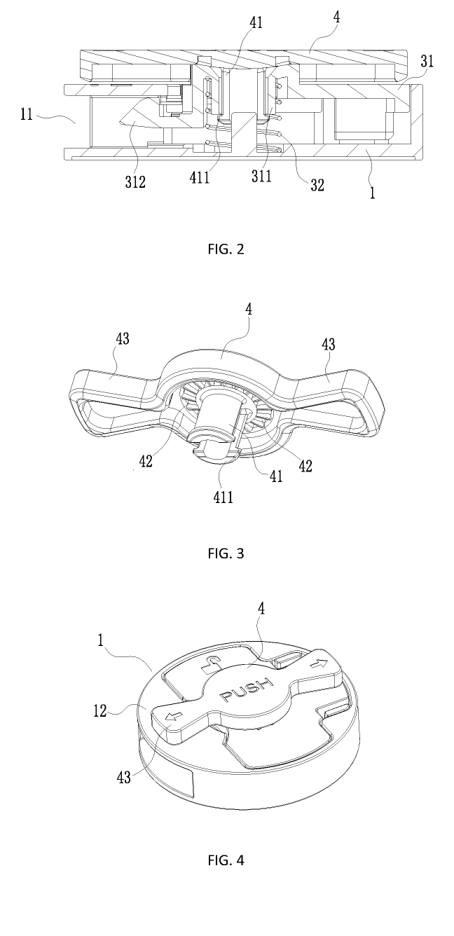

As shown in FIG. 1 and FIG. 2, the present disclosure provides a locking device with a function of preventing accidental unlocking. The device includes a housing 1, the housing 1 is provided with a semi-open cavity 2. Further, the present disclosure further includes a locking mechanism 3 and a rotating member 4, the locking mechanism 3 is movably connected to an interior of the cavity 2, and the rotating member 4 is movably connected to the locking mechanism 3; when in use, the locking mechanism 3 is unlocked by pressing the rotating member 4 after rotation of the rotating member, or the locking mechanism 3 is locked by rotating the rotating member 4; and when the locking mechanism 3 is in a locked state, one side of the rotating member 4 rotates to a top of one side of the housing 1.

Further, as shown in FIG. 1 and FIG. 2, according to the present disclosure, the locking mechanism 3 includes a movable plate 31 and a spring 32, the movable plate 31 is provided with a groove 311 penetrating from top to bottom, one end of the spring 32 is connected to an outer side wall of the groove 311 in a penetrating manner, and the other end of the spring 32 is abutted against a bottom inner surface of the cavity 2; one side of the movable plate 31 is rotatably connected to the interior of the cavity 2, the other side of the movable plate 31 is provided with a lock tongue 312, a side wall of the housing 1 is provided with a slot 11, and the lock tongue 312 is located inside the slot 11; the rotating member 4 is connected to an interior of the groove 311 in a penetrating manner; and when the locking mechanism is in an unlocked state, one side of the rotating member rotates to a top of the movable plate.

It should be pointed out that, as shown in FIG. 1, in order to ensure that the spring 32 does not shift when being compressed, as a preferred technical solution, the bottom inner surface of the cavity 2 is provided with a recessed portion 21, and an end portion of the other end of the spring 32 is accommodated inside the recessed portion 21. Such a structure can effectively prevent the displacement of the spring when the spring is compressed, thereby ensuring the reliability of the present disclosure.

Further, as shown in FIG. 2 and FIG. 3, according to the present disclosure, a connecting column 41 is arranged at a bottom of the rotating member 4, and a limit flange 411 is provided at a peripheral edge of a side wall of one end of the connecting column 41; and when the rotating member 4 is connected to the interior of the groove 311 in a penetrating manner, the limit flange 411 is abutted against an end face of a bottom peripheral edge of the groove 311. This structure can prevent accidental detachment of the rotating member from the groove.

Further, in order to enable the rotating member to rotate better, according to the present disclosure, an interstice available for rotation of the connecting column is reserved between a side wall of the connecting column and an inner side wall of the groove.

Further, as shown in FIG. 1, according to the present disclosure, rotating flanges 313 are respectively provided on one side of the movable plate 31, and the cavity 2 is internally provided with openings 22 formed at positions respectively corresponding to the rotating flanges 313; when one side of the movable plate 31 is rotatably connected to the interior of the cavity 2, the rotating flanges 313 are rotatably connected to interiors of the openings 22; and when the rotating member rotates to a designated position, the movable plate 31 is enabled to rotate along the rotating flanges 313 while the rotating member is pressed.

Further, as shown in FIG. 1 and FIG. 3, according to the present disclosure, positioning members 5 are respectively arranged on opposite sides of a top peripheral edge of the groove 311, one ends of the positioning members 5 are fixedly connected to a surface of the movable plate 31, and the other ends of the positioning members 5 are free ends 51; positioning flanges 52 are provided on tops of the other ends of the positioning members 5, and a plurality of positioning grooves 42 are formed in a bottom peripheral edge of the rotating member 4; and when the rotating member 4 is connected to the interior of the groove 311 in a penetrating manner, the positioning flanges 52 are located in any of the positioning grooves 42.

It should be pointed out that, through the aforementioned cooperation between the positioning flanges of the positioning members and the positioning grooves of the rotating member, the rotating member can be accurately positioned when rotating. What is important is that this structure can simultaneously prevent the free rotation of the rotating member. In addition, such a rotating structure brings better rotating hand feeling to a user and thus improves product friendliness.

Further, as shown in FIG. 1, FIG. 3 and FIG. 4, according to the present disclosure, handles 43 are respectively formed on opposite sides of the rotating member 4 in a manner of extending outward; and when the locking mechanism is in the locked state, one of the handles 43 is located on the top of one side of the housing 1.

As a variation of the present disclosure, the handles on both sides of the rotating member of the present disclosure may also be arranged in a mutually perpendicular structure.

As another variation of the present disclosure, there may also be one handle on the rotating member of the present disclosure.

In fact, in order to achieve effective locking of the present disclosure, the pressing of the rotating member of the present disclosure should be restricted. Specifically, as shown in FIG. 1 and FIG. 4, a surface of the top of one side of the housing 1 of the present disclosure can be referred to as a limiting area 12. The limiting area 12 is not in contact with the handles 43 of the rotating member 4 in a normal state, but when the handles 43 are located within the limiting area 12, the rotating member 4 can only contact the limiting area 12 and is obstructed by the limiting area 12 after the rotating member 4 being pressed, making it unable to compress the spring and thus unable to rotate the movable plate downward, ultimately ensuring that the lock tongue and locking hole are always in a connected and locked state.

Based on the locking device with a function of preventing accidental unlocking, the present disclosure also provides a lock with a function of preventing accidental unlocking. It should be pointed out that the lock can be especially used for avoiding the danger caused by children accidentally unlocking articles.

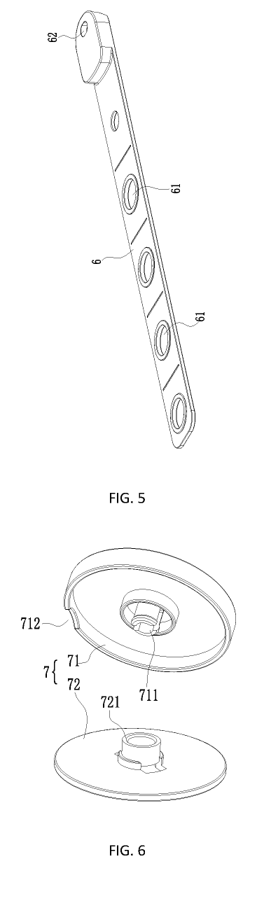

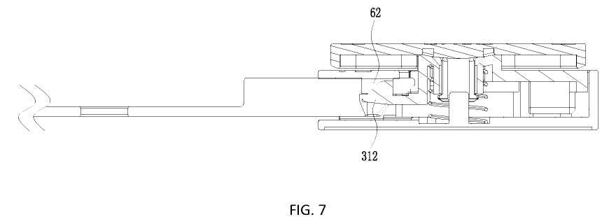

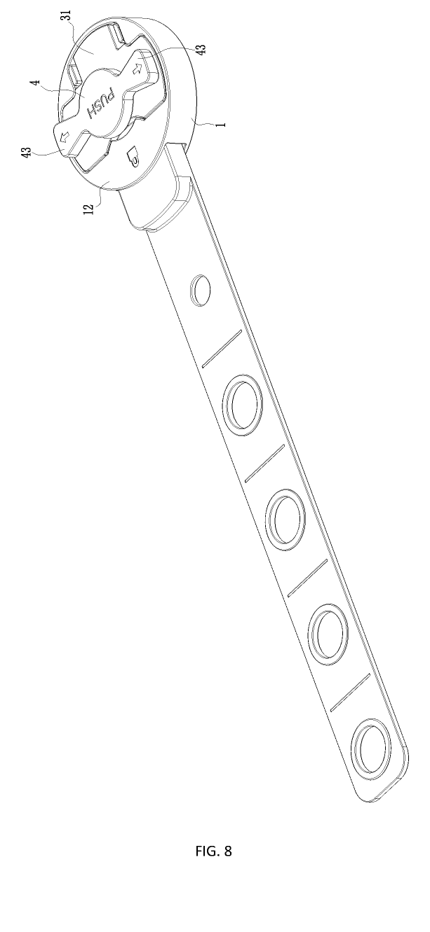

Further, as shown in FIG. 5, FIG. 6 and FIG. 7, the lock includes a connecting band 6 and a fixing mechanism 7, where a plurality of equidistant fixing holes 61 are reserved at one side of the connecting band 6, and a locking hole 62 is reserved at the other side of the connecting band 6; the fixing mechanism 7 is movably connected to any of the fixing holes 61; and when the locking mechanism is in the locked state, the lock tongue 312 is connected to an interior of the locking hole 62.

Further, as shown in FIG. 5 and FIG. 6, according to the present disclosure, the fixing mechanism 7 includes a fixed cover 71 and a fixed seat 72 movably connected to the fixed cover 71; a positioning column 721 is arranged on a surface of the fixed seat 72, and a bottom of the fixed cover 71 is provided with a fastening column 711 at a position corresponding to the positioning column 721; and when in use, the positioning column 721 is connected to an interior of any of the fixing holes 61 in a penetrating manner, and the fastening column 711 is inserted into the positioning column 721.

It should be pointed out that in order to prevent accidental detachment of the fastening column from the positioning column, the fastening column may be arranged in the same structural manner as the aforementioned connecting column. That is, a limit flange is provided at a peripheral edge of a side wall of one end of the fastening column, and the limit flange is abutted against an end face of a bottom peripheral edge of the positioning column, so that the fastening column is prevented from accidentally detaching from the positioning column.

Further, according to the present disclosure, bottom outer surfaces of the locking mechanism and the fixing mechanism are respectively provided with traceless adhesive for bonding.

Still further, for the convenience of sales, when selling the present disclosure, release paper is pasted on a surface of the traceless adhesive to ensure the traceless adhesive stickiness.

Still further, as shown in FIG. 6, in order to facilitate a user to separate the fixed cover 71 from the fixed seat 72, an arc-shaped hole site 712 may be provided in a side wall of the fixed cover 71 of the present disclosure, which facilitates the use of tools or fingers to separate the fixed cover 71 from the fixed seat 72.

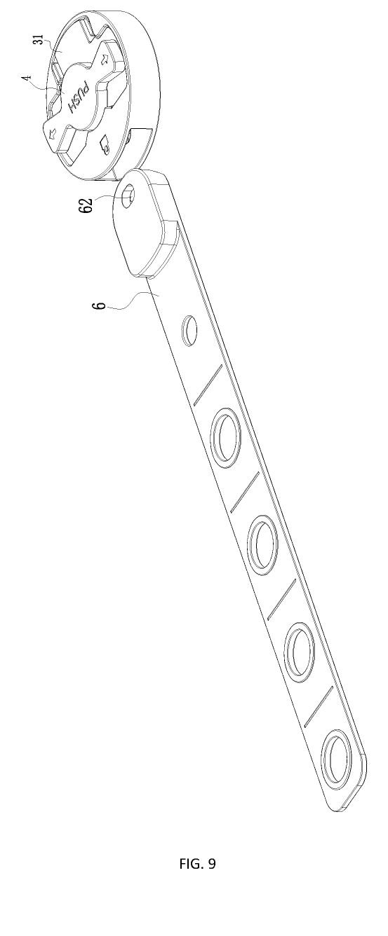

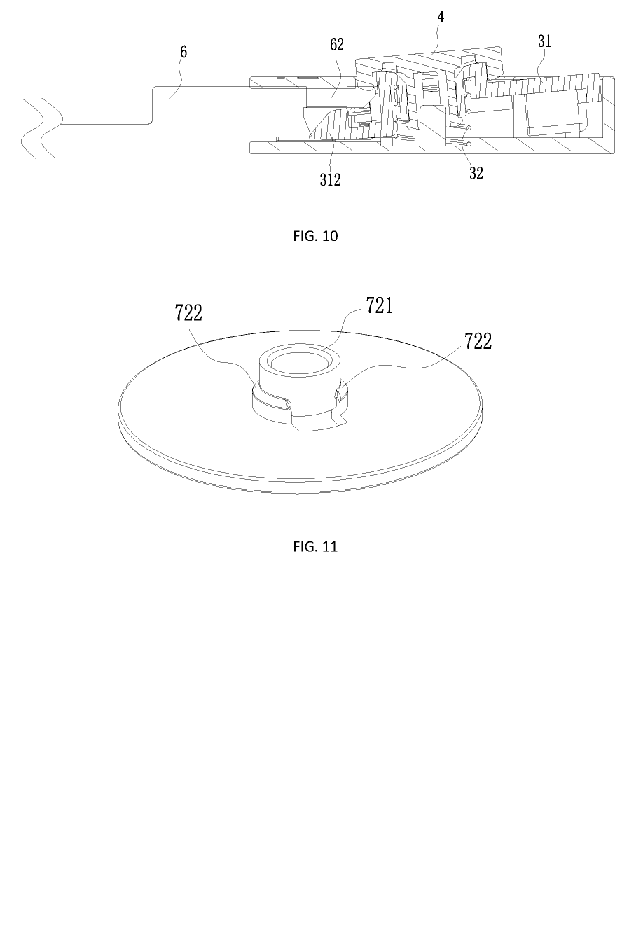

Further, as shown in FIG. 8, FIG. 9 and FIG. 10, FIG. 8 shows a first unlocked state, where the handles 43 on both sides of the rotating member are located on the top of the movable plate 31 after rotation of the rotating member 4. At this time, due to the lack of restriction by the limiting area 12 of the housing 1, the rotating member 4 can be freely pressed. Still further, both FIG. 9 and FIG. 10 show a second unlocked state, where after the rotating member 4 is pressed, on the one hand, the spring 32 is compressed; and on the other hand, the movable plate 31 rotates downward along the rotating flanges, causing the lock tongue 312 of the movable plate 31 to disengage from the locking hole 62 of the connecting band 6, and the connecting band 6 disengages from the locking device, so that unlocking is ultimately achieved.

As a preferred technical solution, as shown in FIG. 11, in order to make it easier to connect the connecting band with the fixing mechanism, a step can be set at the periphery of the positioning column 721, which is an outward sloping surface. When any fixed hole of the connecting band is connected to the positioning column 721, the above-mentioned sloping surface step 722 can make it easier for the positioning column 721 to slide into any positioning hole.

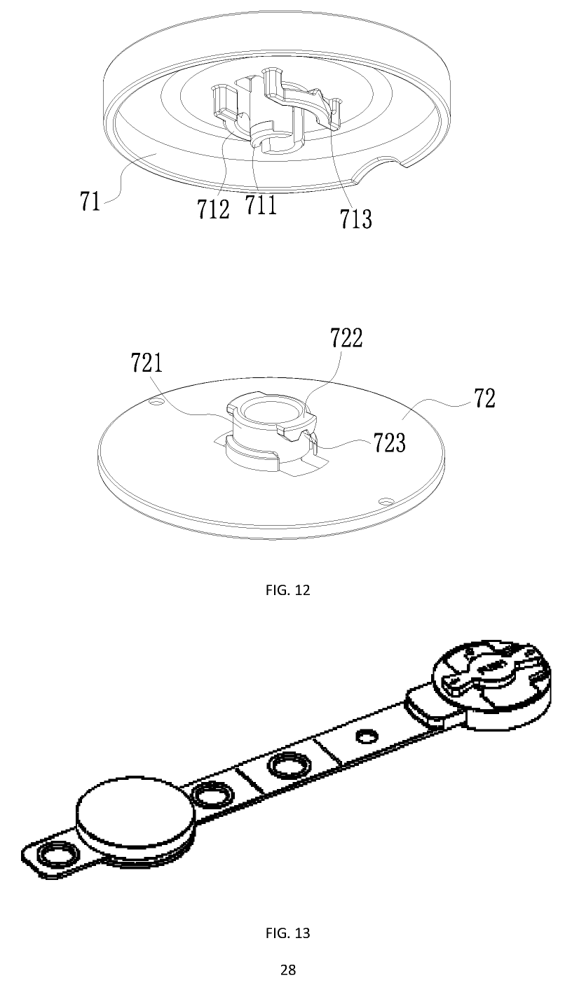

As another variation of the preferred technical solution mentioned above, as shown in FIG. 12, in order to better connect the fixed cover 71 and the fixed seat 72, a flange 722 is provided on the top periphery of the positioning column 721 located on the fixed seat 72, and a limiting groove 723 is provided in the flange 722. Correspondingly, a fastening piece 712 corresponding to the position of the flange 722 is provided around the periphery of the fastening column 711 of the fixed cover 71, and a convex strip 713 is provided in the fastening piece 712; When the fixed cover 71 is connected to the fixed seat 72, the locking column 711 is inserted into the positioning column 721, and the flange 722 is located in the locking piece 712. By rotating the fixed cover 71, the protruding strip 713 is further engaged in the groove 723.

### Embodiment

In order to explain the working principle of the present disclosure in a simple way, this embodiment uses a drawer on a cabinet as an application object. However, this embodiment is only for a better understanding of the present disclosure, and is not intended to limit the scope of use of the present disclosure.

### Installation before use:

The locking mechanism and the fixing mechanism are fixed and pasted respectively. Specifically, the release paper on the traceless adhesive at the bottom of the locking mechanism is removed, the locking mechanism is pasted onto an outer vertical surface of the drawer, and the connecting band is then locked to the locking mechanism, that is, the handles of the rotating member are rotated to the top of the movable plate, so that the locking mechanism is unlocked. After that, one end of the locking hole of the connecting band is inserted into the slot formed at one side of the housing. Since the locking mechanism is in an unlocked state at this time, after one end of the locking hole of the connecting band is inserted, a downward force will be applied to the lock tongue on the movable plate, causing the movable plate to rotate downward along the rotating flanges. At the same time, the spring is compressed. When the lock tongue is connected to the locking hole, the spring is reset and the movable plate is enabled to move upward, so that the locking of the locking mechanism and the connecting band is achieved; and then, the rotating member is rotated to turn the handles to the surface of the limiting area on one side of the housing, so as to implement locking. At this point, the fixed cover of the fixing mechanism is separated from the fixed seat, the release paper on the traceless adhesive at the bottom of the fixed seat is removed, and the fixed seat is pasted onto a lateral outer vertical surface of the drawer according to an appropriate length. The positioning column on the fixed seat is enabled to penetrate through one of the fixing holes formed in the connecting band. Finally, the fixed cover is re-fastened to the fixed seat to complete the installation of the present disclosure. At the same time, the drawer is locked by the lock provided by the present disclosure.

It should be pointed out that the installation positions of the locking mechanism and the fixing mechanism mentioned above can be swapped, that is, the locking mechanism is pasted onto the lateral outer vertical surface of the drawer, and the fixing mechanism is pasted onto the outer vertical surface of the drawer.

### Unlocked state:

When unlocking is required, a user can operate with one hand. Specifically, the handles of the rotating member are rotated so as to be move away from the limiting area on the housing and rotated to a top area of the movable plate. Then, the rotating member is pressed, and the spring is driven to compress under the downward pressure of the rotating member. At the same time, the movable plate is forced to rotate downward along the rotating flanges, and finally the lock tongue on the movable plate is disengaged from the locking hole of the connecting band. At this time, a user can immediately open the drawer. After the drawer is pulled outward, the connecting band will be synchronously driven to disengage from the locking mechanism, thus completing the unlocking.

### Locked state:

When it is necessary to relock, the drawer is firstly closed again, and then one end of the locking hole of the connecting band is inserted into the slot on one side of the housing. Since the locking mechanism is in an unlocked state at this time (i.e., the handles of the rotating member are located in the top area of the movable plate), after one end of the locking hole of the connecting band is inserted, a downward force will be applied to the lock tongue on the movable plate, causing the movable plate to rotate downward along the rotating flanges, and the spring is compressed at this time. When the lock tongue is connected to the locking hole, the spring is reset and the movable plate is enabled to rotate upward, so that the locking of the locking mechanism and the connecting band is achieved; and then, the rotating member is rotated to turn the handles to the surface of the limiting area on the housing, so as to implement relocking.

For those skilled in the art, various corresponding changes and variations can be given based on the above technical solutions and concepts, and all these changes and variations shall be included in the protection scope of the claims of the present disclosure.

What is claimed is:

1. A locking device with a function of preventing accidental unlocking, comprising: a housing provided with a semi-open cavity, wherein the locking device further comprises a locking mechanism and a rotating member, the locking mechanism is movably connected to an interior of the cavity, and the rotating member is movably connected to the locking mechanism; when in use, the locking mechanism is unlocked by pressing the rotating member after rotation of the rotating member, or the locking mechanism is locked by rotating the rotating member; and when the locking mechanism is in a locked state, one side of the rotating member rotates to a top of one side of the housing.

2. The locking device with a function of preventing accidental unlocking according to claim 1, wherein the locking mechanism comprises a movable plate and a spring, the movable plate is provided with a groove penetrating from top to bottom, one end of the spring is connected to an outer side wall of the groove in a penetrating manner, and the other end of the spring is abutted against a bottom inner surface of the cavity; one side of the movable plate is rotatably connected to the interior of the cavity, the other side of the movable plate is provided with a lock tongue, a side wall of the housing is provided with a slot, and the lock tongue is located inside the slot; the rotating member is connected to an interior of the groove in a penetrating manner; and when the locking mechanism is in an unlocked state, one side of the rotating member rotates to a top of the movable plate.

3. The locking device with a function of preventing accidental unlocking according to claim 2, wherein a connecting column is arranged at a bottom of the rotating member, and a limit flange is provided at a peripheral edge of a side wall of one end of the connecting column; and when the rotating member is connected to the interior of the groove in a penetrating manner, the limit flange is abutted against an end face of a bottom peripheral edge of the groove.

4. The locking device with a function of preventing accidental unlocking according to claim 3, wherein an interstice available for rotation of the connecting column is reserved between a side wall of the connecting column and an inner side wall of the groove.

5. The locking device with a function of preventing accidental unlocking according to claim 2, wherein rotating flanges are respectively provided on one side of the movable plate, and the cavity is internally provided with openings formed at positions respectively corresponding to the rotating flanges; when one side of the movable plate is rotatably connected to the interior of the cavity, the rotating flanges are rotatably connected to interiors of the openings; and when the rotating member rotates to a designated position, the movable plate is enabled to rotate along the rotating flanges while the rotating member is pressed.

6. The locking device with a function of preventing accidental unlocking according to claim 2, wherein positioning members are respectively arranged on opposite sides of a top peripheral edge of the groove, one ends of the positioning members are fixedly connected to a surface of the movable plate, and the other ends of the positioning members are free ends; positioning flanges are provided on tops of the other ends of the positioning members, and a plurality of positioning grooves are formed in a bottom peripheral edge of the rotating member; and when the rotating member is connected to the interior of the groove in a penetrating manner, the positioning flanges are located in any of the positioning grooves.

7. The locking device with a function of preventing accidental unlocking according to claim 1, wherein handles are respectively formed on opposite sides of the rotating member in a manner of extending outward; and when the locking mechanism is in the locked state, one of the handles is located on the top of one side of the housing.

8. A lock provided with the locking device with a function of preventing accidental unlocking according to claim 1, comprising a connecting band and a fixing mechanism, wherein a plurality of fixing holes are reserved at one side of the connecting band, and a locking hole is reserved at the other side of the connecting band; the fixing mechanism is movably connected to any of the fixing holes; and when the locking mechanism is in the locked state, the lock tongue is connected to an interior of the locking hole.

9. The lock according to claim 8 provided with the locking device with a function of preventing accidental unlocking, wherein the fixing mechanism comprises a fixed cover and a fixed seat movably connected to the fixed cover; a positioning column is arranged on a surface of the fixed seat, and a bottom of the fixed cover is provided with a fastening column at a position corresponding to the positioning column; and when in use, the positioning column is connected to an interior of any of the fixing holes in a penetrating manner, and the fastening column is inserted into the positioning column.

10. The lock according to claim 8 provided with the locking device with a function of preventing accidental unlocking, wherein bottom outer surfaces of the locking mechanism and the fixing mechanism are respectively provided with traceless adhesive for bonding.
